(19) United States
(12) Patent Application Publication
(10) Pub. No.: US 2012/0139151 A1
(43) Pub. Date: Jun. 7, 2012

(54) Additive type bio-decomposable composite preparation method

(76) Inventors: Yu-Ying Chen, Linkou Township (TW); Tzu-Ting Hwang, Yongho City (TW)

(21) Appl. No.: 12/926,651

(22) Filed: Dec. 2, 2010

(51) Int. Cl. B29C 47/78

(52) U.S. Cl. 264/148

(57) ABSTRACT

An additive type bio-decomposable composite is prepared by: mixing a synthesized bio-decomposable resin with refined sodium sulphate and additives in a high-low temperature mixing pot at a high mixing, and then crushing the mixture thus obtained and delivering the crushed mixture to a double-screw extruding machine for processing through blending, granulation and cooling steps into a white, uniform, grained, finished product. The additive type bio-decomposable composite thus prepared can be used with any of a variety of plastic materials for making decomposable plastic products that, when become waste after service, will decompose gradually under a variety of natural environmental conditions and return to nature. Therefore, the use of the additive type bio-decomposable composite in accordance with the present invention can reduce pollution and save the plastic material cost and meet environmentally friendly requirements.

### BACKGROUND OF THE INVENTION

1. Field of the Invention

The present invention relates to a bio-decomposable composite preparation method and more particularly, to an additive type bio-decomposable composite preparation method for preparing an additive type bio-decomposable composite by using a mixture of a synthesized bio-decomposable resin with refined sodium sulphate and additives that can be added to a plastic material for making environmentally friendly plastic products to improve the product's temperature resistant property and transparency, and to save the plastic material cost.

2. Description of the Related Art

To solve the indecomposable drawback of regular plastic products, green plants are processed by means of biochemical technology through refine, fermentation and synthesis steps for making decomposable products. The physical and chemical characteristics of bio-decomposable plastic materials of this kind are similar to regular plastic materials, and can be used to substitute for regular plastics materials. However, fabrication and utilization of bio-decomposable materials must be maintained under stable conditions. After service, bio-decomposable products must be decomposed into biomass, carbon dioxide and water within a reasonable period of time. The formation of biomass is helpful to the environment. During the process of the formation of biomass, carbon can be returned to the atmosphere more easily than sintering process. Further, plants can absorb. By means of the application of a compositing technique, biomass can be returned to the nature for recycling.

In regular bio-decomposable materials, the most competitive bio-decomposable plastics are prepared by mixing starch with a synthesized resin. The synthesized resin can be polyethylene (PE), polypropylene (PP), polyvinyl chloride (PVC), polystyrene (PS), etc. Because starch is a carbohydrate consisting of a large number of glucose units joined together by flycosidic bonds, a secondary processing step is necessary, complicating the product manufacturing process. A product made of starch and synthesized resin has low transparency, exhibiting less sense of beauty. Further, the decomposition rate of this product is still not high. With respect to starch related parameter, modification, processing technique and preparation and resin modification, many patents and literatures have been disclosed. However, during the process of blending, the structure of the resin is never changed. However, the residual fragmentary synthesized polymer does not decompose after a certain period of time after decomposition of starch. In consequence, these bio-decomposable plastics are being continuously criticized for being not pollution-free and nor recyclable, and cannot pass bio-decomposition tests.

Therefore, it is desirable to provide a preparation method for making a bio-decomposable composite that eliminates the drawbacks of the conventional techniques of complicated manufacturing process, high manufacturing cost, low decomposition rate and unsatisfactory bio-decomposition test results.

### SUMMARY OF THE INVENTION

The present invention has been accomplished under the circumstances in view. It is one object of the present invention to provide an additive type bio-decomposable composite preparation method, which is practical for preparing a synthesized bio-decomposable composite that can be added to any of a variety of plastic materials (PE, PP, PS, ABS, etc) for making environmentally friendly, bio-decomposable plastic products to improve the product's temperature resistant property and transparency and to save the plastic material cost.

To achieve this and other objects of the present invention, an additive type bio-decomposable composite is prepared by: mixing a synthesized bio-decomposable resin with refined sodium sulphate and additives in a high-low temperature mixing pot at a high mixing, and then crushing the mixture thus obtained and delivering the crushed mixture to a double-screw extruding machine for processing through blending, granulation and cooling steps into a white, uniform, grained, finished product that can be added to any of a variety of plastic materials for making plastic bags, plastic utensils (such as: bowl, dish, cup, chopsticks, spoon, knife, fork, lunchbox, dishpan, etc.), straw tubes, storage containers, and many other environmentally friendly plastic products to improve the product's temperature resistant property and transparency, and to save the plastic material cost.

Further, the step of mixing a synthesized bio-decomposable resin with refined sodium sulphate and additives is achieved by: grinding refined sodium sulphate into about 1000 mesh powdered sodium sulphate, and then mixing 40˜60% by weight powdered sodium sulphate with 10˜30% by weight synthesized bio-decomposable resin and 10˜15% by weight additives into a mixture. Further, the synthesized bio-decomposable resin can be polycaprolactone (PCL), polybutylene succinate (PBS) or polylactic acid (PLA). The additives can be paraffin wax, oxidized wax, affinant, coupling agent, calcium stearate, 2-butyl alcohol, ethyl acetate, silicate or sorbic alcohol. The coupling agent can be silanes (such as organic silanes) or organic oxides (such as butyl phthalate). The affinant can be glycerin.

In one embodiment of the present invention, the additive type bio-decomposable composite is prepared by: mixing 40˜60% by weight powdered sodium sulphate with 10˜30% by weight synthesized bio-decomposable resin and 10˜15% by weight additives into a mixture, and then blending the mixture in a high-low temperature mixing pot at a mixing speed about 1000˜2800 rpm and a mixing temperature about 100˜160° C. for about 5˜10 minutes to form a paste-like substance, and then removing the paste-like substance from the mixing pot and using an electrical fan to cool down the paste-like substance into a hard mass, and then using a crusher to crush the hard mass into a crushed material, and then using a conveyer to deliver the crushed material to a granulator, and then operating the granulator to have the crushed material be blended and granulated at a temperature about 120˜220° C. under a pressure about 5˜20 MPa for about 3˜12 minutes, and then drawing the granulated material thus obtained into a bar-like material through a cold-drawing process, and then using an electrical fan to cool down the bar-like material and then cutting the bar-like material into the desired finished material.

The additive type bio-decomposable composite thus obtained can be added to any of a variety of plastic materials prepared for making plastic bags, plastic utensils (such as: bowl, dish, cup, chopsticks, spoon, knife, fork, lunchbox, dishpan, etc.), straw tubes, storage containers, and many other environmentally friendly plastic products to improve the product's temperature resistant property (from 60° C. to 80˜100° C.) and transparency (lowering the fogging extent of the product), and to save the plastic material cost.

### BRIEF DESCRIPTION OF THE DRAWINGS

FIG. 1 is an additive type bio-decomposable composite preparation flow chart in accordance with the present invention.

### DETAILED DESCRIPTION OF THE PREFERRED EMBODIMENT

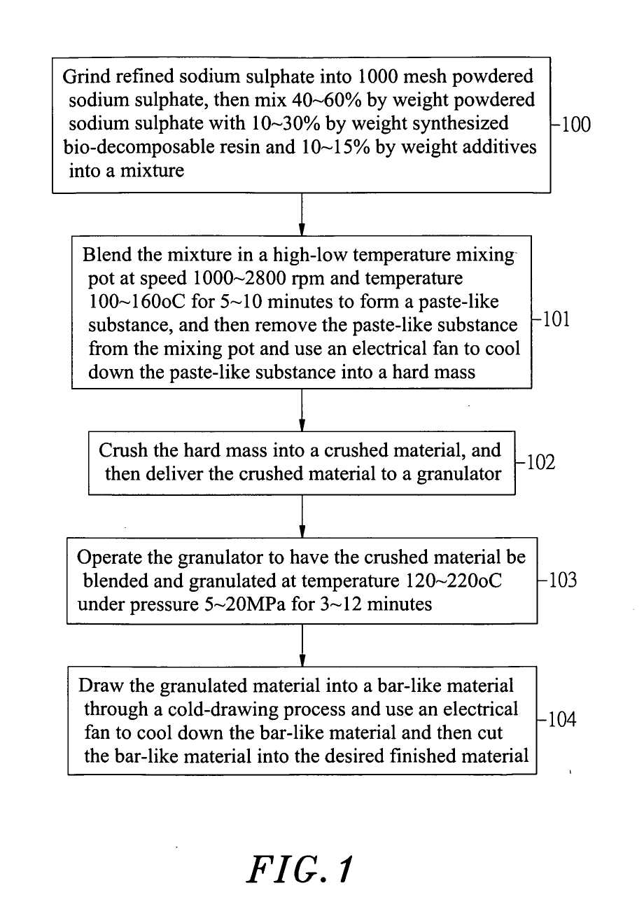

Referring to FIG. 1, an additive type bio-decomposable composite in accordance with the present invention is prepared subject to the following steps:
(100) Grind refined sodium sulphate into about 1000 mesh powdered sodium sulphate, and then mix 40˜60% by weight powdered sodium sulphate with 10˜30% by weight synthesized bio-decomposable resin and 10˜15% by weight additives into a mixture.
(101) Blend the mixture in a high-low temperature mixing pot at a mixing speed about 1000˜2800 rpm and a mixing temperature about 100˜160° C. for about 5˜10 minutes to form a paste-like substance, and then remove the paste-like substance from the mixing pot and use an electrical fan to cool down the paste-like substance into a hard mass.
(102) Use a crusher to crush the hard mass into a crushed material, and then use a conveyer to deliver the crushed material to a granulator.
(103) Operate the granulator to have the crushed material be blended and granulated at a temperature about 120˜220° C. under a pressure about 5˜20 MPa for about 3˜12 minutes.
(104) Draw the granulated material thus obtained into a bar-like material through a cold-drawing process, and then use an electrical fan to cool down the bar-like material and then cut the bar-like material into the desired finished material.

In the aforesaid preparation method, the mixing temperature during step (101) is most preferably at 125° C., and the blending temperature during step (103) is most preferably at 125° C. Under a high temperature, high pressure and high shearing force environment, the crushed material is homogeneously blended so that partial branched group causes a polymerization reaction. After granulation, a white granular product is obtained. Because the substances for the bio-decomposable composite are water soluble, they are compatible to one another during blending, facilitating blending operation. After blended, the product is soft and paste-like. The cold-drawing process is to draw the material to a length about 21 meters long for cooling by an electrical fan.

The aforesaid synthesized bio-decomposable resin can be polycaprolactone (PCL), polybutylene succinate (PBS) or polylactic acid (PLA). The aforesaid additives can be paraffin wax, oxidized wax, affinant, coupling agent, calcium stearate, 2-butyl alcohol, ethyl acetate, silicate or sorbic alcohol. The coupling agent can be silanes (such as organic silanes) or organic oxides (such as butyl phthalate). The affinant can be glycerin.

The additive type bio-decomposable composite thus prepared can be added to a plastic material, such as polyethylene (PE), polypropylene (PP) or polystyrene (PS) subject to a predetermined ratio for making bio-decomposable plastic products. For example, 30% bio-decomposable composite with 70% plastic material, or 40% bio-decomposable composite with 60% plastic material. The ratio may be adjusted to fit different requirements for different users. An additive type bio-decomposable composite-added plastic material prepared according to the present invention can be used for making plastic bags, plastic utensils (such as: bowl, dish, cup, chopsticks, spoon, knife, fork, lunchbox, dishpan, etc.), straw tubes, storage containers, and many other products. Adding the bio-decomposable composite to a plastic material for making plastic products can improve the product's temperature resistant property (from 60° C. to 80˜100° C.) and transparency (lowering the fogging extent of the product), and save the plastic material cost. Because the products thus made are bio-decomposable, they are environmentally friendly.

As stated above, the additive type bio-decomposable composite comprises 40˜60% by weight refined sodium sulfate, 10˜30% by weight synthesized bio-decomposable resin and 10˜15% by weight additive, wherein the synthesized bio-decomposable resin is prepared from a compound of which the main chain contains lateral ester, —OH, COOH or keto, such as polycaprolactone (PCL), polybutylene succinate (PBS) or polylactic acid (PLA); the additive is selected from the group of paraffin wax, oxidized wax, affinant (glycerin), coupling agent selected from the group of silanes (such as organic silanes) and organic oxides (such as butyl phthalate), calcium stearate, 2-butyl alcohol, ethyl acetate, silicate and sorbic alcohol.

The additive type bio-decomposable composite prepared in accordance with the present invention can be mixed with different plastic materials for making different plastic products that are bio-decomposable under any of a variety of natural environmental conditions after their serviced. Examples of the preparation of the bio-decomposable composite in accordance with the invention are outlined thereinafter:

### Example I

60 Kgs sodium sulfate (about 1000 mesh powdered status) was mixed with 15 Kgs polycaprolactone (PCL), 10 Kgs polybutylene succinate (PBS), 7 Kgs glycerin (affinant), 3 Kgs organic silanes (coupling agent) and 5 Kgs additive in a high-low temperature mixing pot at a mixing speed about 1400 rpm and a mixing temperature about 80° C. for about 10 minutes to form a white, uniform mixture, and then the white, uniform mixture was put in a hopper and guided into a double-screw extruding machine and processed under a processing temperature about 120˜200° C. and a processing pressure about 10˜15 MPa for about 5 minutes. After blending, granulation and cooling steps, a white, uniform, grained product of grain size about 2 mm was obtained. When the bio-decomposable composite becomes a waste product, it will be decomposed gradually under a variety of natural environmental conditions and return to nature.

### Example II

50 Kgs sodium sulfate (about 1000 mesh powdered status) was mixed with 30 Kgs polybutylene succinate (PBS), 8 Kgs glycerin (affinant), 2 Kgs butyl phthalate (coupling agent) and 10 Kgs additive in a high-low temperature mixing pot at a mixing speed about 1400 rpm and a mixing temperature about 100° C. for about 10 minutes to form a white, uniform mixture, and then the white, uniform mixture was put in a hopper and guided into a double-screw extruding machine and processed under a processing temperature about 120˜185° C. and a processing pressure about 5˜15 MPa for about 5 minutes. After blending, granulation and cooling steps, a white, uniform, grained product of grain size about 2 mm was obtained. When the bio-decomposable composite becomes a waste product, it will be decomposed gradually under a variety of natural environmental conditions and return to nature.

### Example III

70 Kgs sodium sulfate (about 1000 mesh powdered status) was mixed with 10 Kgs polybutylene succinate (PBS), 8 Kgs glycerin (affinant), 5 Kgs butyl phthalate (coupling agent) and 7 Kgs additive in a high-low temperature mixing pot at a mixing speed about 1400 rpm and a mixing temperature about 100° C. for about 10 minutes to form a white, uniform mixture, and then the white, uniform mixture was put in a hopper and guided into a double-screw extruding machine and processed under a processing temperature about 120˜200° C. and a processing pressure about 10˜15 MPa for about 5 minutes. After blending, granulation and cooling steps, a white, uniform, grained product of grain size about 2 mm was obtained. When the bio-decomposable composite becomes a waste product, it will decompose gradually under a variety of natural environmental conditions and return to nature.

An additive type bio-decomposable composite prepared according to either of the aforesaid various examples of the present invention can be added to any of a variety of plastic materials (PE, PP, PS, ABS, etc) for making decomposable plastic products. When becoming waste after service, the decomposable plastic products will decompose gradually under a variety of natural environmental conditions and return to nature. Therefore, the use of the additive type bio-decomposable composite in accordance with the present invention can reduce pollution and save the plastic material cost and meet environmentally friendly requirements.

The above examples are simply for understanding of the present invention and not intended for use as limitations of the invention. In general, an additive type bio-decomposable composite is prepared by mixing a synthesized bio-decomposable resin with refined sodium sulphate and additives in a high-low temperature mixing pot at a high mixing, and then crushing the mixture thus obtained and delivering the crushed mixture to a double-screw extruding machine for processing through blending, granulation and cooling steps into a white, uniform, grained. The additive type bio-decomposable composite thus prepared can be used with any of a variety of plastic materials for making decomposable plastic products that, when become waste after service, will decompose gradually under a variety of natural environmental conditions and return to nature. Therefore, the use of the additive type bio-decomposable composite in accordance with the present invention can reduce pollution and save the plastic material cost and meet environmentally friendly requirements.

In general, the additive type bio-decomposable composite and its preparation of the present invention have the advantages as follows:

1. The additive type bio-decomposable composite uses refined sodium sulphate to substitute for starch. Because it is easy to get sodium sulphate, the preparation of the additive type bio-decomposable composite avoids food waste and meets environmentally friendly requirements.
2. The additive type bio-decomposable composite comprising synthesized bio-decomposable resin, refined sodium sulphate and additives can be added to any of a variety of plastic materials (PE, PP, PS, ABS, etc) for making bio-decomposable plastic products to improve the product's temperature resistant property and transparency and to save the plastic material cost. Because the products are bio-decomposable, they are environmentally friendly.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An additive type bio-decomposable composite preparation method, comprising the steps of:
(a) grinding refined sodium sulphate into about 1000 mesh powdered sodium sulphate, and then mixing 40˜60% by weight powdered sodium sulphate with 10˜30% by weight synthesized bio-decomposable resin and 10˜15% by weight additive into a mixture;
(b) blending said mixture in a high-low temperature mixing pot at a mixing speed about 1000˜2800 rpm and a mixing temperature about 100˜160° C. for about 5˜10 minutes to form a paste-like substance, and then removing said paste-like substance from said mixing pot and using an electrical fan to cool down said paste-like substance into a hard mass and using a crusher to crush said hard mass into a crushed material;
(c) delivering said crushed material to a granulator by means of a conveyer;
(d) operating said granulator to have said crushed material be blended and granulated at a temperature about 120˜220° C. under a pressure about 5˜20 MPa for about 3˜12 minutes;
(e) drawing said granulated material thus obtained into a bar-like material through a cold-drawing process, and then cooling down said bar-like material and then cutting said bar-like material into the desired finished material.

2. The additive type bio-decomposable composite preparation method as claimed in claim 1, wherein said synthesized bio-decomposable resin is prepared from a compound having contained in the main chain thereof one of lateral ester, —OH, COOH, keto and their compositions.

3. The additive type bio-decomposable composite preparation method as claimed in claim 2, wherein said synthesized bio-decomposable resin is selected from the group of polycaprolactone (PCL), polybutylene succinate (PBS), polylactic acid (PLA) and their combinations.

4. The additive type bio-decomposable composite preparation method as claimed in claim 1, wherein said additives are selected from the group of paraffin wax, oxidized wax, affinant, coupling agent, 2-butyl alcohol, ethyl acetate, silicate and sorbic alcohol.

5. The additive type bio-decomposable composite preparation method as claimed in claim 4, wherein said coupling agent is selected from the group of silanes and organic oxides; said affinant is glycerin.

6. The additive type bio-decomposable composite preparation method as claimed in claim 5, wherein said silane is organic silane.

7. The additive type bio-decomposable composite preparation method as claimed in claim 5, wherein said organic oxide is butyl phthalate.

8. The additive type bio-decomposable composite preparation method as claimed in claim 1, wherein the optimal mixing temperature in step (b) is preferably about 125° C.

9. The additive type bio-decomposable composite preparation method as claimed in claim 1, wherein said crushed material is blended and granulated in step (d) preferably at the temperature about 125° C.

10. The additive type bio-decomposable composite preparation method as claimed in claim 1, wherein cooling down said bar-like material in step (e) is performed subject to the operation of an electrical fan.
